(19) United States
(12) Patent Application Publication
(10) Pub. No.: US 2016/0321659 A1
(43) Pub. Date: Nov. 3, 2016

(54) REPORT GENERATION USING EVENT INFRASTRUCTURE

(71) Applicant: Microsoft Technology Licensing, LLC, Redmond, WA (US)

(72) Inventors: David Annesley-DeWinter, Redmond, WA (US); Ian Williams, Seattle, WA (US); Yi Lang Mok, Bellevue, WA (US); Brett Marl, Seattle, WA (US)

(21) Appl. No.: 14/699,953

(22) Filed: Apr. 29, 2015

(51) Int. Cl. G06Q 20/40; G06Q 40/00

(52) U.S. Cl. CPC G06Q 20/405; G06Q 40/12

(57) ABSTRACT

The infrastructure that is used to process transactions may be used to create a report, thereby reducing the number of physical interactions involved to create a report. In one example, a pre-authorization for an event occurs and is sent to a real-time monitor. The real-time monitor identifies the physical location of the event, names associated with the event, and the purpose of the event. Further information about the event is then collected from a person who participates in the event. The event is then sent to a pending report monitor, which awaits notice of completion of the event from the physical infrastructure in which the event occurs. Once notice of event completion is received, the completed report of the event is submitted without further interaction with the person involved in the event.

### BACKGROUND

Generating reports of one's activities can be a nuisance, but it is often a necessary one. Many businesses or organizations require reports of an employee's expenses and/or activities, in order to justify payment of the expenses or to verify that the employee is performing his or her job function. Traditionally, reports were generated on paper and submitted in physical paper form. With the ubiquity of computers and smart phones, much of paper has been replaced with electronic data. But even with the use of electronic data, the process of generating the report works much the same as it does on paper in the sense that the generation of the report is manually initiated by the person who has to file it. The process of generating reports is further complicated by the fact that the information needed to complete the report may not be available until several days after the underlying event to be reported has been completed.

### SUMMARY

Expense reports may be generated automatically from the infrastructure that is used to process transactions that are the subject of the report. When a person engages in a purchase transaction, a report of this transaction is generated by the institution that processes payment on the transaction. This report is communicated to a real-time monitor, which then concludes that the person has a transaction that he or she is currently engaging in, or has recently engaged in. The information from this report is used, along with other information such as the location of the transaction, to determine the name of the entity that has been paid. The name of this entity, as well as any other context information that may be available about the user, is used to determine the purpose of the transaction. Once the purpose of the transaction has been determined, the purpose is sent to the person's mobile device, which generates a request that the person enter information about the transaction that is appropriate to the transaction's purpose. When the requested information has been received, the transaction is saved in a pending state. Entities that handle payments provide a feed of settled transactions. This feed is monitored, and, when the feed data indicates that the transaction has settled, a report based on the transaction is filed, without the person's further involvement. The report can be filed automatically, without the person's further involvement even if the transaction settles several days or weeks after the information was entered.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example system in which reports may be generated and submitted.

FIG. 2 is a flow diagram of an example process for determining which pending transaction corresponds to a given settled transaction.

FIG. 3 is a flow diagram of an example process in which expense reports may be generated.

FIG. 4 is a block diagram of example components that may be used in connection with implementations of the subject matter described herein.

### DETAILED DESCRIPTION

In many situations, it is necessary to generate a report of one's activities or expenses. Expense reports by employees are used to justify reimbursement to those employees, or to justify charging an expense to an expense account. Reports of activities are used to verify that the employee is performing a job function. Traditionally, expenses and activities are memorialized in a process that results in a generation of a physical paper report. The generation and filing of paper reports can be a nuisance for various reasons. First, generation of the paper report often involves transferring to paper information that already exists in electronic form—e.g., copying data from an electronic credit card receipt to a paper report. Second, generation of a paper report often involves marshaling information that does not exist at the time of the event to be reported. When a purchase is made by credit card, the transaction is generally not complete until it clears the financial institution that issued the credit card, possibly a day or more after a purchase. For example, the initial authorization of a restaurant transaction may be $50, but that authorization may be an approximate amount generated by the restaurant, where the exact amount is known only after the purchaser enters the tip. Or, a gas station may obtain authorization for $100 when a driver swipes his credit card, but the exact amount of purchase is known only after the fuel is dispensed. Since the employee who reports the expense may need evidence of a completed transaction, the employee has to revisit the event after the purchase has been completed. The result of this inconvenience is that people often save their reports until the end of the next reporting period (e.g., the end of the month), and then have to marshal information to reconstruct reportable events.

With the ubiquity of computers and smart phones, much of paper has been replaced with electronic data. But even with the use of electronic data, the process of generating the report works much the same as it does on paper in the sense that the generation of the report is manually initiated by the person who has to file it. The process of generating reports (paper or electronic) is further complicated by the fact that the information needed to complete the report may not be available until several days after the underlying event to be reported has been completed.

The subject matter herein leverages the physical infrastructure in which modern transactions take place to reduce the physical labor involved in creating reports. Rather than merely using electronic devices to perform a process that could otherwise be performed on paper, the subject matter herein uses a way in which transactions are processed by machine, and a way in which information concerning the transactions is communicated between machines, in order to generate reports. The subject matter makes use of the physical infrastructure in which payments are processed to reduce the number of interactions that a user has to engage in with a device in order to generate a report. In this sense, the technical effect of reducing wear and tear on the user's device is produced, as well as the technical effects of reducing the user's workload to complete the task of preparing and submitting a report, reducing the amount of time needed to prepare and submit the report, and reducing the possibility of errors in preparing and submitting the report. Moreover, the way in which the reports are generated is not an abstraction that involves using a computer to implement an otherwise paper process. Rather, the physical infrastructure that exists to approve payments or other transactions makes it possible to generate sufficient information for a report before the transaction is complete, and therefore allows a user to provide sufficient information for a report at the time the transaction is made. Additionally, the ability to identify the nature, purpose, and participants in a transaction is based partly on the physical ability of a computer system that is remote from the user to identify, in real time, the user's location at the time of the transaction, and thus is not merely the computer implementation of an otherwise human business process.

When a person engages in a purchase transaction by credit card or some other non-cash mechanism, an authorization for the transaction is generated. The purpose of this authorization is to let the merchant know that the money to fund the transaction is available and its use has been authorized, but the authorization alert is leveraged for a different purpose: to start the generation of a report that is to be completed later. The alert may contain very little information, such as an amount of money (which may or may not be the actual amount of the transaction), and a code that represents the name of the merchant. A real-time expense monitor receives the alert, and uses the alert to start the process of collecting relevant information about the transaction from the user and from other sources. The user's device (e.g., phone, tablet, etc.) may prompt him to enter information about the transaction, such as the transaction's purpose, who was present, etc. Additionally, the alert may set in motion the process of marshalling information about the transaction from other sources. For example, the code name for the merchant contained in the authorization alert may be sent to a name mapping database to identify the merchant's actual business name. The type of merchant and the time at which the transaction took place may be used to infer the business purpose of the transaction. (E.g., a transaction at a restaurant that takes place at 8:00 a.m. may be inferred to be a breakfast business meeting.) Various other inferences are possible, which are described more particularly by examples below. In general, the relationship between the information provided and the identity of the merchant, business category, business purpose, etc., may be created in any manner. One example of how to create this relationship is to use machine learned heuristics, in which the system learns to identify the correct merchant identity, purpose, category, etc., based on which proposals are accepted by the system's users.

Once any inferences about the transaction have been drawn, and once the user has entered information about the transaction, the transaction is placed in a pending state. A pending report monitor waits for notice that the transaction has cleared. The notice that the transaction has cleared may include details that need to be filled in for a report, such as the final amount of the transaction (as in the restaurant tip and gas stations examples above). One the transaction has been completed and the appropriate information has been added to the report, the report may be filed. It is noted that the actual filing of the report may take place a long after the transaction has occurred, without any further involvement from the person who incurred the expense. Thus, unlike the traditional report-filing process in which a person typically has to interact with the details of a report both at the time of the reportable transaction and then again at the time of filing, using the techniques provided herein the user may only have to interact with the details of the report one time.

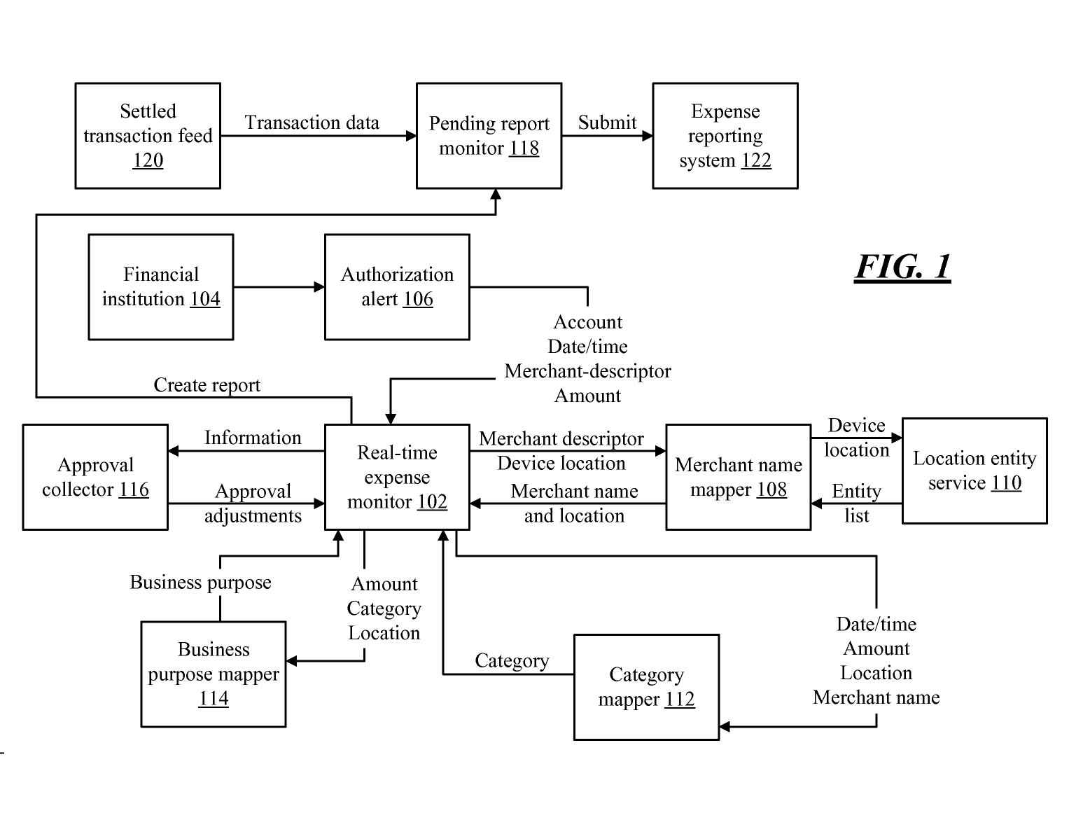

Turning now to the drawings, FIG. 1 shows an example system in which reports may be generated and submitted. The example of FIG. 1 shows a system that may be used to generate and submit expense reports, although these components may be used to submit other types of reports, such as employee activity reports.

A real-time expense monitor 102 runs as a service. This service may exist at any location, a typically exists as a cloud-based service. Real-time expense monitor 102 may continuously monitor data coming from financial institution 104. Such data typically comes from financial institution 104 in the form of authorization alerts 106. When a purchase is made (e.g., on a credit card, debit card, etc.), an alert containing an authorization transaction is sent from financial institution 104 to the real-time expense monitor 102. This transaction may have various pieces of information, such as the account the transaction pertains to, the date and/or time of the transaction, the amount of the transaction and a merchant descriptor. It is noted that the ability to obtain this information about a transaction from such early information as the authorization for a charge uses the physical infrastructure in which financial institutions process payments. Thus, the use of such authorization information is not a mere abstraction, and also produces at least the technical effects of reducing the use of the user's device (and, therefore, wear and tear on that device), reducing the user's workload to complete the task of preparing and submitting a report, reducing the amount of time needed to prepare and submit the report, and reducing the possibility of errors in preparing and submitting the report.

In order to obtain user-approval for a business expenses, a system may need to show to the user, and/or collect from the user, certain pieces of information. These pieces of information may include the date of the expense, where the expense occurred (e.g., city and state, for tax-collecting purposes), the amount of the expense, an accurate merchant name, the category of the expense, and the business purpose of the expense. Of this information, typically only the date and amount is available through the authorization transaction. Furthermore, the merchant descriptor provided is often a very messy and incomplete string. E.g., a purchase at the Home Depot store in Bellevue, Wash., might show “HOME DEPO* #104” indicating store #104 at Home Depot, even though a meaningful vendor name such as “Home Depot” might be required for an actual expense report.

To fill in the required information, the cloud service may use the authorization transaction data together with geographic coordinates from the user's mobile device (which may be used pursuant to appropriate permission obtained from the user in order to protect the user's interest in privacy—e.g., the user may be asked whether he will permit an expense report app on his phone to use his location). Thus, after real-time expense monitor 102 receives an authorization alert from a financial institution, real-time expense monitor 102 also obtains the geographic coordinate from the user's mobile device (pursuant to appropriate permission from the user to protect the user's interest in privacy, as described above). The geographic coordinates may be latitude/longitude coordinates, or may contain other types of information, such as information from local beacons present in a retail environment such as an indoor shopping mall or airport.

The merchant descriptor and any geographic data may be provided by real-time expense monitor 102 to merchant name mapper 108. Merchant name mapper 108 may send the geographic information to location entity service 110, which is a component that searching a repository of business entities and returns a list of possible matches for the geographic location. It is noted that the use of the user's physical location to help to identify the merchant reduces the user's need to interact with the device (e.g., in order to enter a merchant name, or to correct a mis-identified merchant); therefore, the use of the user's physical location reduces wear and tear on the device, reduces the user's workload to complete the task of preparing and submitting a report, reduces the amount of time needed to prepare and submit the report, and reduces the possibility of errors in preparing and submitting. Therefore, the use of the user's physical location produces a technical effect and does not constitute the mere computer-implementation of an otherwise human process. Merchant name mapper 108 then uses the list that is returned by location entity service 110 and probabilistically identifies the name of the entity at which the transaction took place, based on how well the user's device's current location matches the known location of business entities in the list, and also based on how closely the merchant name descriptor matches the names of entities in the list. Once merchant name mapper 108 settles on a matching business entity, a merchant name and the merchant's location are returned by merchant name mapper 108 to real-time expense monitor 102.

Real-time expense monitor 102 then provides information about the transaction (e.g., date, time, amount, location, and merchant name) to category mapper 112. Category mapper 112 uses this data to determine the likely category of the transaction. Categories might include airline, taxi, on-board meal, client meal, employee meal (where meal may be further subdivided into categories such as breakfast, lunch, and dinner), etc. Category mapper 112 provides the identified category back to real-time expense monitor 102. Real-time expense monitor 102 then passes information concerning the transaction (such as the amount of the transaction, the category determined by category mapper 112, location, and merchant name) to business purpose mapper 114. Business purpose mapper 114 generates a human-readable business purpose of the transaction, such as “taxi to airport” or “breakfast with client” that justifies the purchase. The business purpose determined by business purpose mapper 114 is then provided back to real-time expense monitor 102

At this point, real-time expense monitor 102 has enough information to display the expense details to a user for the user's approval. This information is passed to approval collector 116. Approval collector 116 shows the information to the user and requests that the user make changes to correct the data (e.g., pick a different category, transaction, or merchant name than the one suggested). The user may also be asked to add information, such as a photograph of a receipt. When the user has made any such changes, or approved the transaction information as-is, the approved information is sent back to real-time expense monitor 102, and may be stored with a time stamp.

At this point, real-time expense monitor connects to the pending report monitor 118 and adds the transaction to a pending expense report that is to be submitted once the transaction settles. At some point in the future (e.g., 3-10 days later), pending report monitor 118 receives information from settled transaction feed 120 that the transaction has settled. The report is then submitted to expense reporting system 122 with all required details for the expense report filled out. The amount of the transaction may change when the transaction changes from its authorized state to the settled state—e.g., in the case where the purchaser hand-wrote a restaurant tip that was entered after the initial authorization, or in the case where the user dispenses fuel after authorization for a pay-at-the-pump fuel purchase. Pending report monitor 118 employs a transaction matching algorithm to detect which items in the settled transaction feed 120 correspond to the pending reports.

The category mapping algorithm is employed by the category mapper 112 in order to best select a category for a specific transaction given a number of inputs. Because the invention is designed as a generic system that can work with any back-end reporting system and any specific corporate configuration on such a system, there is a complexity involved in Category Mapping. For example—some companies might wish for category to be emitted as “Employee Meals”, while others sub-divide such as “Meals—Breakfast”, “Meals—Lunch” etc.

As noted above, the system described in FIG. 1 determines both the category of a transaction (using category mapper 112) and the purpose of the transaction (using business purpose mapper 114). The following are some examples of determining categories and business purpose:

In one example, an airline such as “United Airlines” might yield spending categories of type “Airfare”, “Airline Fees”, “Onboard Meals” etc. The system would look at the amount and time of the expense. If the expense occurred during the scheduled flight time and the amount was low, the system might select “Onboard Meals” as the suggested category.

In another example, if the merchant name corresponds to a restaurant and time of day is early morning, the system may select an employee meal sub-category of Breakfast, or a generic Employee Meal category and a business purpose of Breakfast. If the restaurant amount is over the individual meal limit of the business users company, the system could suggest “Entertainment—Client Meals” as opposed to “Employee Meal” as the category.

In another example, the system could use information from the user's online or desktop calendar to resolve conflicts. E.g., if the user's calendar indicates that the user is on a flight, then a meal expense occurring while the user is on the flight suggests that the category and/or purpose include an “in flight meal.” Or, if the user's calendar indicates that the user is at a client dinner during the time that the meal expense occurs, then this fact can be used to help determine that the appropriate category and/or purpose include a “client meal.”

In another example, the Business Purpose Mapper could use context to generate the likely business purpose. For example, if the category of an expense is “taxi,” and the user's current location is an airport, then the nature of the expense can be described as “taxi to <name of airport>”. Or, if the expense category is “taxi” and the location is home or work, then the nature of the expense can be described as Taxi to <home or work>.” Similar inferences can be made about taxi rides to restaurants, to customer locations, etc.

The pending report monitor 118 (described above in connection with FIG. 1) receives notice of settled transactions, but then has to match these settled transactions with the pending transactions. Since pending and settled transactions are often not linked by a common transaction identifies, a matching process has to be used to match the pending and settled transactions. Some information that may change between from the time of authorization until the time of settlement are:
The date. The pre-transaction date is normally correct per the time of incurring the charge, however the settled transaction date often reflects the settlement date—which can be several days different from the authorization.
The amount. The pre-auth amount can change incrementally or dramatically. E.g., a restaurant authorization is for base-bill amount, but the settled bill might be 15-20% higher to reflect the tip. Or, a gas station authorization might be for $1 to validate a card, but the settled transaction is the actual amount spent on fuel.
The identity or name of the merchant. In some cases, the merchant name changes across transactions, since the payee might be a different entity from the owner of the point-of-sale system that initiates the authorization.

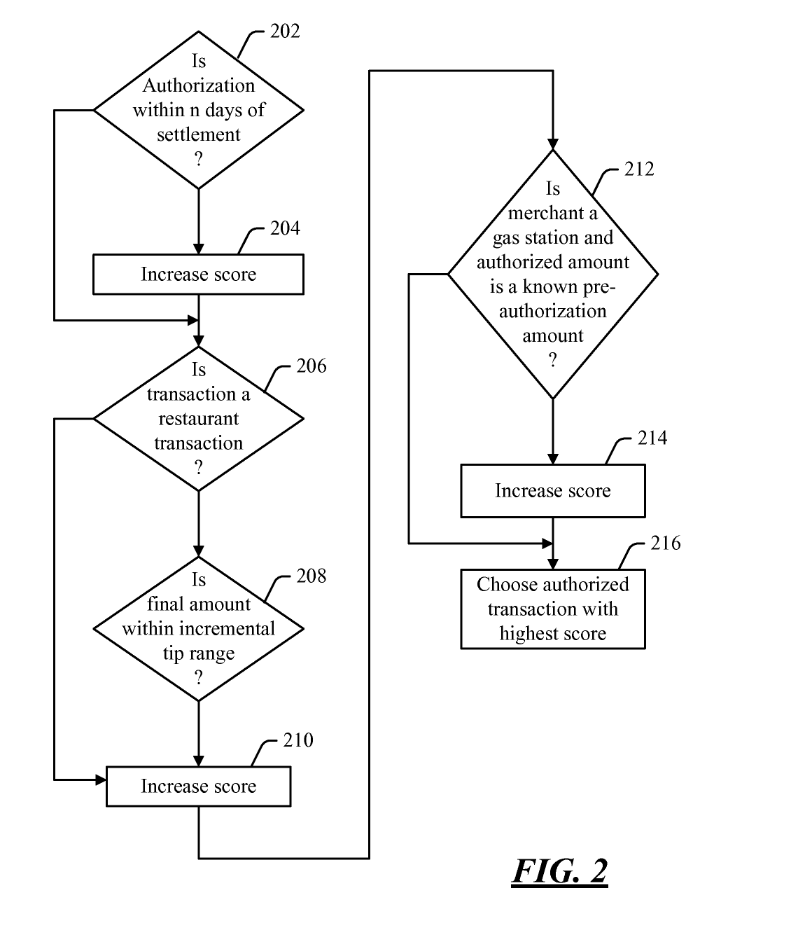

FIG. 2 shows an example process of determining which pending transaction corresponds to a given settled transaction. When the system receives notice of a settled transaction, the process of FIG. 2 assigns a score to one or more pending transactions, based on the likelihood that each of the pending transactions matches the newly-arrived settled transaction

If the authorization was made within n days of the settled transaction (as determined at 202), then the score is increased (block 204). Typical values of n include 2 days or 3 days, although any amount of time could be used as a value of n. If the settled transaction is a restaurant transaction (as determined at 206), and if the final amount is within a specific incremental range of the authorized amount (e.g., no more than 20% higher, no more than 25% higher, etc.), as determined at 208, then the score is increased (block 210). If the merchant in a settled transaction is a gas station, and the authorized amount is a pre-authorization amount commonly known to be used by gas stations (e.g., $1), as determined at 212, then the score is increased (block 214). After scores are calculated for some or all of the pending transactions, the pending transaction with the highest score is chosen as the match for the newly-arrived settled transaction (at block 216).

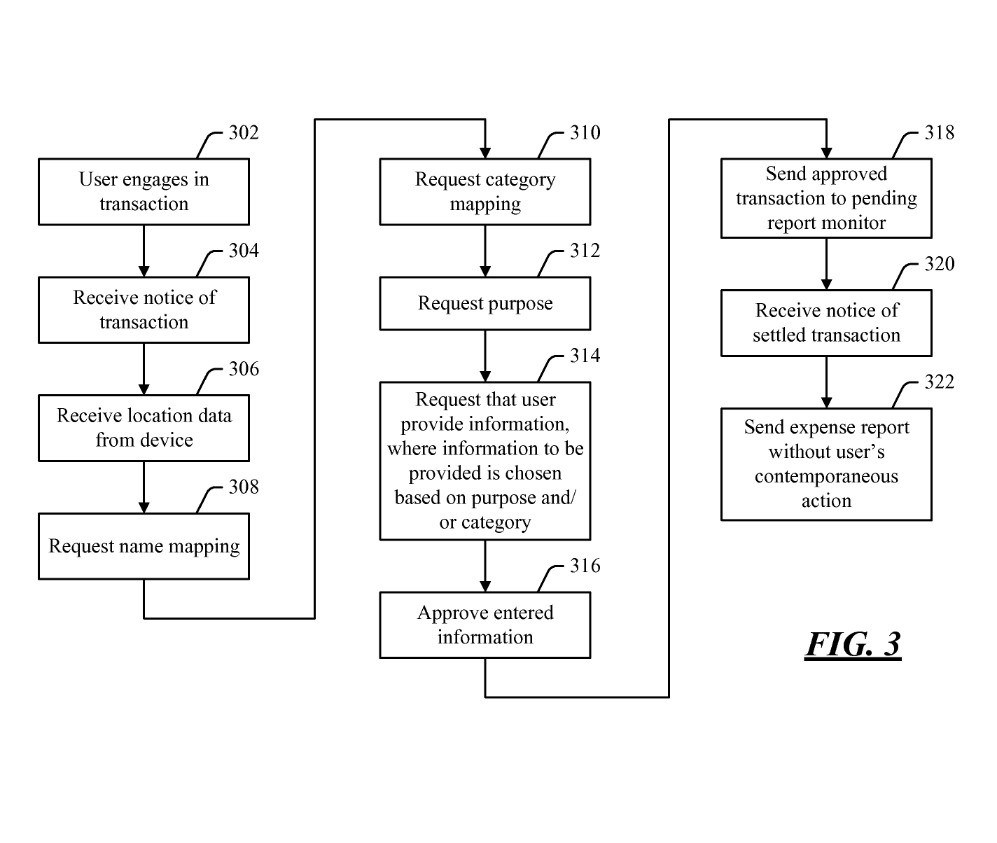

FIG. 3 shows an example process in which expense reports may be generated. It is noted that the subject matter described herein may be used to generate any type of report, rather than merely expense reports. Thus, the expense report generation process shown in FIG. 3 is to be understood as an example of a process that generates reports, and does not limit the subject matter herein to expense reports.

At 302, a user engages in a purchase or payment transaction. The transaction may be a transaction to purchase a meal, a transaction to purchase fuel, a transaction to pay a hotel bill, a transaction to rent a car, or any other purchase transaction. At 304, a real-time expense monitor receives notice of the transaction. In one example, such notice is triggered when the user uses a credit or debit card for the transaction, thereby causing an authorization request to be generated. This authorization request may be communicated by a financial institution to a real-time expense monitor.

At 306, real-time monitor may receive location data from the user's device (pursuant to appropriate permission from the user, in order to protect the user's interest in privacy). At 308, the real-time monitor may request that the name stated in the notification be mapped a user-friendly name. The location of the device and/or a database of business names may be used to map a symbolic or abbreviated merchant name contained in an authorization with the known name of a business.

At 310, the real-time monitor may request a category of the transaction. At 312, the real-time monitor may request a purpose of the transaction. The process of determining the category and purpose of the transaction may take place serially (in either order), or may take place concurrently.

Once the category and purpose have been determined, the user may be asked to provide certain information (at 314). For example, the system may have determined that the category and/or purpose of the expense is a business lunch with a client, in which case the user may be asked to enter the name of the client. Or, the system may have determined that the category and/or purpose of the expense was a taxi ride, in which case the user may be asked to enter the name of the destination (or to select the name of the destination from a drop-down list, in the case, for example, where the geographic location of the destination is an office building that has several different businesses). It is noted that the particular information that is requested of the user is chosen based on the category and/or purpose of the expense—e.g., one would not ask a user to enter a destination if the category and/or purpose has been determined to be a client lunch.

Once the user has entered the requested information, the user may be asked to confirm that the expense describe in the report actually occurred. Additionally, the information entered may be validated to determine that contains the required information for an expense report and/or any information required for a specific type of expense. If the entered information validates, then the report, including the information entered by the user, is approved (at 316). The approved transaction is then sent to a pending request monitor (at 318) to await settlement of the transaction. When notice of the settled transaction is received (at 320), the expense report based on the combination of the pending report and the settled transaction may be submitted for processing and payment (at 322). The submission of the report may take place without further user involvement—i.e., when the user provides whatever information was requested at 314, the user's involvement is done, and the process of waiting for the transaction settlement and submitting the report can proceed without further user involvement. It is noted that this aspect of the process is different from anything that could be achieved merely by using a computer to process expenses in a traditional way: traditional expense reports require that the user marshal information at the time of the transaction and then submit the expense report at a later date. The process described herein, by leveraging the particular type of infrastructure that is used to process payments, allow the user to interact with the process of generating an expense report only once—at the time the transaction occurs—and then to have an expense report submitted automatically on his behalf at some later date.

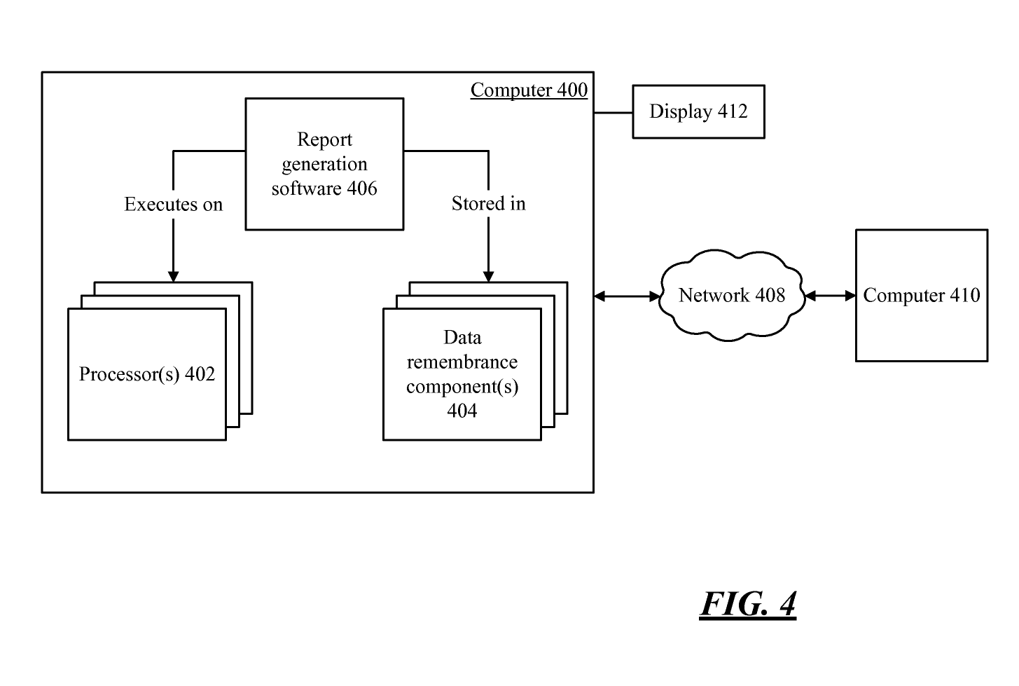

FIG. 4 shows an example environment in which aspects of the subject matter described herein may be deployed.

Computer 400 includes one or more processors 402 and one or more data remembrance components 404. Processor(s) 402 are typically microprocessors, such as those found in a personal desktop or laptop computer, a server, a handheld computer, or another kind of computing device. Data remembrance component(s) 404 are components that are capable of storing data for either the short or long term. Examples of data remembrance component(s) 404 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 400 may comprise, or be associated with, display 412, which may be a cathode ray tube (CRT) monitor, a liquid crystal display (LCD) monitor, or any other type of monitor.

Software may be stored in the data remembrance component(s) 404, and may execute on the one or more processor(s) 402. An example of such software is report generation software 406, which may implement some or all of the functionality described above in connection with FIGS. 1-3, although any type of software could be used. Software 406 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 4, although the subject matter described herein is not limited to this example.

The subject matter described herein can be implemented as software that is stored in one or more of the data remembrance component(s) 404 and that executes on one or more of the processor(s) 402. As another example, the subject matter can be implemented as instructions that are stored on one or more computer-readable media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable media, regardless of whether all of the instructions happen to be on the same medium.

The term “computer-readable media” does not include signals per se; nor does it include information that exists solely as a propagating signal. It is noted that there is a distinction between media on which signals are “stored” (which may be referred to as “storage media”), and—in contradistinction—media that exclusively transmit propagating signals without storing the data that the signals represent. DVDs, flash memory, magnetic disks, etc., are examples of storage media. On the other hand, the fleeting, momentary physical state that a wire or fiber has at the instant that it is transmitting a signal is an example of a signal medium. (Wires and fibers can be part of storage media that store information durably, but information that exists only as the fleeting excitation of electrons in a wire, or only as the pulse of photons in a fiber, constitutes a signal.) It will be understood that, if the claims herein refer to media that carry information exclusively in the form of a propagating signal, and not in any type of durable storage, such claims will use the term “signal” to characterize the medium or media (e.g., “signal computer-readable media”, or “signal device-readable media”). Unless a claim explicitly uses the term “signal” to characterize the medium or media, such claim shall not be understood to describe information that exists solely as a propagating signal or solely as a signal per se. Additionally, it is noted that “hardware media” or “tangible media” include devices such as RAMs, ROMs, flash memories, and disks that exist in physical, tangible form, and that store information durably; such “hardware media” or “tangible media” are not signals per se, are not propagating signals, and these terms do not refer media in which information exists exclusively as a propagating signal. Moreover, “storage media” are media that store information. The term “storage” is used to denote the durable retention of data. For the purpose of the subject matter herein, information that exists only in the form of propagating signals is not considered to be “durably” retained. Therefore, “storage media” include disks, RAMs, ROMs, etc., but does not include information that exists only in the form of a propagating signal because such information is not “stored.”

Additionally, any acts described herein (whether or not shown in a diagram) may be performed by a processor (e.g., one or more of processors 402) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 400 may be communicatively connected to one or more other devices through network 408. Computer 410, which may be similar in structure to computer 400, is an example of a device that can be connected to computer 400, although other types of devices may also be so connected.

In one example, the subject matter comprises a computer-readable medium that comprises executable instructions to report events, where the executable instructions, when executed by a first computer, cause the first computer to perform acts comprising: receiving an indication that a person has engaged in an event, the indication comprising a record of the event generated by a second computer that is remote from the first computer and that is distinct from the first computer; identifying a type to which the event belongs; based on the type, identifying a set of data to be collected from the person; receiving the data from the person; storing the data with a record of the event, the aid record of the event comprising an incomplete record of the event in a sense that the record of the event lacks a piece of information that is required, by an entity, for recordation of the event; receiving, from a third computer that is remote from and distinct from the first computer and the second computer, the piece of information, and adding the piece of information to the record; and recording the record of said event. There may be a plurality of categories of events, and the events may belong to one of the categories, where the type comprises that category. There may be a plurality of different purposes for events, where the type comprises one of the purposes, the event having been determined to be for that purpose. The event may comprise charging of a payment, where the recording of the record of said event comprises submitting an expense report. The indication may comprise an authorization transaction for the payment. The authorization transaction may identify, by a string, a merchant at which the payment was made, where the acts further comprise requesting that a mapper identify a name for the merchant based on the string. The acts may further comprise requesting that the mapper identify the name for the merchant further based on a location of the first computer.

In another example, the subject matter comprises a method of generating a report, the method comprising: using a first computer to perform acts comprising: receiving an indication that a person has engaged in payment transaction, the indication comprising an authorization transaction for said payment transaction; identifying a type to which the payment transaction belongs; based on the type, identifying a set of data to be collected from the person; receiving the data from the person; storing the data with a record of the authorization transaction, the record comprising an incomplete record of the payment transaction in a sense that the record of the payment transaction lacks a piece of information that is required, by an entity, for recordation of the payment transaction; receiving, from a third computer that is remote from and distinct from the first computer and the second computer, the piece of information, and adding the piece of information to the record; and submitting an expense report that comprises the record including the piece of information. The authorization transaction may identify, by a string, a merchant at which payment was made, the acts further comprising: requesting that a mapper identify a name of the merchant based on the string. The acts may further comprise requesting that the mapper identify the name of the merchant further based on a location of the first computer. The piece of information may comprise settlement of said the payment, where the acts further comprise: determining that the settlement relates to the payment based on a number of days that have elapsed between the authorization transaction and the settlement. The piece of information may comprise settlement of the payment, the payment being made to a restaurant, where the acts further comprise: determining that the settlement relates to the payment based on a first amount of the payment in the authorization transaction being within a given percentage of a second amount of the payment in the settlement. The piece of information may comprise settlement of the payment, the settlement indicating that the payment is made to a gas station, where the acts may further comprise determining that the settlement relates to the payment based on the authorization transaction being for an amount that is known to be used by gas stations for charge authorizations.

In another example, the subject matter may comprise a system for reporting events, where the system comprises: a memory; a processor; and a component that is stored in the memory, that executes on the processor, the component receiving an indication that a person has engaged in an event, the indication comprising a record of the event generated by a first computer that is remote from the system and that is distinct from the system, the component identifying a type to which the event belongs, the component identifying a set of data to be collected from the person based on the type, the component receiving the data from the person, the component storing the data with a record of the event, the record of the event comprising an incomplete record of the event in a sense that the record of the event lacks a piece of information that is required, by an entity, for recordation of the event, the component receiving, from a second computer that is remote from and distinct from the system and the first computer, the piece of information, the component adding the piece of information to the record, and the component recording the record of the event. There may be a plurality of categories of events, where the event belong to one of the categories, and the type may comprise that category. There may be a plurality of different purposes for events, where the type comprises one of the purposes, where the event has been determined to be for that purpose. The event may comprise charging of a payment for transportation, where the component adds an origin or destination for the transportation based on a physical location of the system at a time at which said event occurs. The indication may comprise an authorization transaction for the payment. The piece of information may comprise settlement of the payment, where the component may determine that the settlement relates to the payment based on a number of days that have elapsed between the authorization transaction and the settlement. The piece of information may comprise settlement of the payment, where the payment may be made to a restaurant, and the component may determine that the settlement relates to the payment based on a first amount of the payment in the authorization transaction being within a given percentage of a second amount of the payment in the settlement.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium comprising executable instructions to report events, the executable instructions, when executed by a first computer, causing the first computer to perform acts comprising:
receiving an indication that a person has engaged in an event, said indication comprising a record of said event generated by a second computer that is remote from said first computer and that is distinct from said first computer;
identifying a type to which said event belongs;
based on said type, identifying a set of data to be collected from said person;
receiving said data from said person;
storing said data with a record of said event, said record of said event comprising an incomplete record of said event in a sense that said record of said event lacks a piece of information that is required, by an entity, for recordation of said event;
receiving, from a third computer that is remote from and distinct from said first computer and said second computer, said piece of information, and adding said piece of information to said record; and
recording said record of said event.

2. The computer-readable medium of claim 1, there being a plurality of categories of events, said event belonging to one of said categories, said type comprising said one of said categories.

3. The computer-readable medium of claim 1, there being a plurality of different purposes for events, said type comprising one of said purposes, said event having been determined to be for said one of said purposes.

4. The computer-readable medium of claim 1, said event comprising charging of a payment, said recording of said record of said event comprising submitting an expense report.

5. The computer-readable medium of claim 4, said indication comprising an authorization transaction for said payment.

6. The computer-readable medium of claim 5, said authorization transaction identifying, by a string, a merchant at which said payment was made, said acts further comprising:
requesting that a mapper identify a name for the merchant based on the string.

7. The computer-readable medium of claim 6, further comprising:
requesting that said mapper identify said name for said merchant further based on a location of said first computer.

8. A method of generating a report, the method comprising:
using a first computer to perform acts comprising:
receiving an indication that a person has engaged in payment transaction, said indication comprising an authorization transaction for said payment transaction;
identifying a type to which said payment transaction belongs;
based on said type, identifying a set of data to be collected from said person;
receiving said data from said person;
storing said data with a record of said authorization transaction, said record comprising an incomplete record of said payment transaction in a sense that said record of said payment transaction lacks a piece of information that is required, by an entity, for recordation of said payment transaction;
receiving, from a third computer that is remote from and distinct from said first computer and said second computer, said piece of information, and adding said piece of information to said record; and
submitting an expense report that comprises said record including said piece of information.

9. The method of claim 8, said authorization transaction identifying, by a string, a merchant at which a payment was made, said acts further comprising:
requesting that a mapper identify a name of said merchant based on said string.

10. The method of claim 9, said acts further comprising:
requesting that said mapper identify said name of said merchant further based on a location of said first computer.

11. The method of claim 8, said piece of information comprising settlement of said payment, said acts further comprising:
determining that said settlement relates to said payment based on a number of days that have elapsed between said authorization transaction and said settlement.

12. The method of claim 8, said piece of information comprising settlement of said payment, said payment being made to a restaurant, said acts further comprising:
determining that said settlement relates to said payment based on a first amount of said payment in said authorization transaction being within a given percentage of a second amount of said payment in said settlement.

13. The method of claim 8, said piece of information comprising settlement of said payment, said settlement indicating that said payment is made to a gas station, said acts further comprising:
determining that said settlement relates to said payment based on said authorization transaction being for an amount that is known to be used by gas stations for charge authorizations.

14. A system for reporting events, the system comprising:
a memory;
a processor; and
a component that is stored in said memory, that executes on said processor, said component receiving an indication that a person has engaged in an event, said indication comprising a record of said event generated by a first computer that is remote from said system and that is distinct from said system, said component identifying a type to which said event belongs, said component identifying a set of data to be collected from said person based on said type, said component receiving said data from said person, said component storing said data with a record of said event, said record of said event comprising an incomplete record of said event in a sense that said record of said event lacks a piece of information that is required, by an entity, for recordation of said event, said component receiving, from a second computer that is remote from and distinct from said system and said first computer, said piece of information, said component adding said piece of information to said record, and said component recording said record of said event.

15. The system of claim 14, there being a plurality of categories of events, said event belonging to one of said categories, said type comprising said one of said categories.

16. The system of claim 14, there being a plurality of different purposes for events, said type comprising one of said purposes, said event having been determined to be for said one of said purposes.

17. The system of claim 14, said event comprising charging of a payment for transportation, said component adding an origin or destination for said transportation based on a physical location of said system at a time at which said event occurs.

18. The system of claim 17, indication comprising an authorization transaction for said payment.

19. The system of claim 18, said piece of information comprising settlement of said payment, said component determining that said settlement relates to said payment based on a number of days that have elapsed between said authorization transaction and said settlement.

20. The system of claim 18, said piece of information comprising settlement of said payment, said payment being made to a restaurant, said component determining that said settlement relates to said payment based on a first amount of said payment in said authorization transaction being within a given percentage of a second amount of said payment in said settlement.
